(19) United States
(12) Patent Application Publication
(10) Pub. No.: US 2024/0261876 A1
(43) Pub. Date: Aug. 8, 2024

(54) DEPTH SETTER TOOL

(71) Applicant: Phillips Screw Company, Amesbury, MA (US)

(72) Inventor: Gary E. Dilling, Ashburnham, MA (US)

(73) Assignee: Phillips Screw Company, Amesbury, MA (US)

(21) Appl. No.: 18/432,487

(22) Filed: Feb. 5, 2024

Related U.S. Application Data
(60) Provisional application No. 63/444,017, filed on Feb. 8, 2023.

(51) Int. Cl. B23B 49/00

(52) U.S. Cl. CPC B23B 49/005; B23B 2260/0482; B23B 2260/12

(57) ABSTRACT

A depth setter tool includes a spacer having an inner diameter sized to fit around a shank of a driver bit such that the spacer can rotate about an axis passing through a center of the driver bit and independently of the driver bit. The spacer further includes an opening extending along an entire length of the spacer from a first end of the spacer to a second end of the spacer. The opening provides access to the inner diameter thereby allowing the spacer to be engaged onto the shank of the driver bit. The depth setter tool also includes a stopper. In an example, the stopper is donut-shaped and includes a compliant material that engages around the first end of the spacer.

### CROSS REFERENCE TO RELATED APPLICATION

This application claims the benefit of and priority to U.S. Provisional Application No. 63/444,017, filed Feb. 8, 2023, the disclosure of which is incorporated by reference herein in its entirety.

### FIELD OF THE DISCLOSURE

This disclosure relates to fastener systems, and more particularly, to a depth setter tool.

### BACKGROUND

Fastener applications sometimes require the fastener to be set at a given depth within a workpiece. This may be accomplished by pre-drilling counterbore holes into the board (or other workpiece) using a counterbore tool, which allows for subsequently setting the fastener deeper within the pre-drilled hole. Alternatively, the fastener may be driven below the workpiece surface to a pre-determined depth in a single action, rather than using a separate counterbore process followed by a driving process. In either case, a plug may be installed to conceal the head of the countersunk fastener.

### BRIEF DESCRIPTION OF THE DRAWINGS

FIGS. 1A and 1B each illustrates a perspective view of a depth setter tool, in accordance with an embodiment of the present disclosure.

FIG. 2 illustrates the separate components of the depth setter tools depicted in FIGS. 1A and 1B, in accordance with an embodiment of the present disclosure.

FIGS. 3A-3C illustrate a procedure of coupling a spacer over a narrower torsion zone of a driver bit shank of the depth setter tool, in accordance with an embodiment of the present disclosure.

FIGS. 4A and 4B illustrate additional views of the depth setter tool, in accordance with some embodiments of the present disclosure.

FIGS. 5A-5C illustrate more detailed cross-section views of the depth setter tool and portions of the depth setter tool, in accordance with some embodiments of the present disclosure.

### DETAILED DESCRIPTION

A depth setter tool is disclosed. According to an embodiment, the depth setter tool is an assembly that includes a snap-fit or press-fit elongated spacer that fits around the shank of a driver bit. With the spacer installed on the driver bit shank, a donut-like stopper is pressed onto an end of the spacer close to the driver bit tip, such that the bit tip protrudes from the hole of the stopper. The combination of the spacer and the stopper can spin freely around the shank of the driver bit but is restricted from moving axially along the shank due to the shape of the shank. Accordingly, when drilling a fastener into a workpiece, the stopper will eventually contact the surface of the workpiece and stop spinning and prevent any further inward driving of the fastener while the drill bit can continue to spin independently of the spacer and stopper. In this manner, the fastener is driven into the workpiece at a desired depth, such that the top surface of the fastener head is flush with the workpiece surface or just below the workpiece surface so as to allow room for a plug to hide the fastener. In some examples, the elongated spacer can be plastic, and the stopper can be rubber, although any number of other suitable materials can be used. In some examples, the stopper is pressed over a first end of the spacer and a washer is arranged at a second opposite end of the spacer such that the washer is between the spacer and a portion of the shank. In any such examples, the driver bit may be configured as an impact bit that includes a narrower torsion zone between the bit tip end and chuck end of the driver bit. In some such examples, the spacer is configured to snap or press fit around the torsion zone, rather than the thicker end portions of the shank. If present, the hole of the washer can be sized to fit over the bit tip and slide to the end of the narrow torsion zone, and abut the thicker end portion of the shank. Such a washer configuration may help further stabilize the spacer during driving operations. Other embodiments may not include the washer, wherein an end surface of the spacer itself abuts the thicker end portion of the shank. Numerous embodiments will be appreciated in light of this disclosure.

In an embodiment, a depth setter tool includes a spacer having an inner diameter sized to fit around a shank of a driver bit such that the spacer can rotate about an axis passing through a center of the driver bit and independently of the driver bit. The spacer has an opening or slot extending along an entire length of the spacer from a first end of the spacer to a second end of the spacer. The opening provides access to the inner diameter thereby allowing the spacer to be engaged onto the shank of the driver bit (such as by way of a press-fit or snap-fit). The depth setter tool also includes a stopper with a compliant material and is designed to engage the first end of the spacer.

In another embodiment, a depth setter tool includes a driver bit having a bit tip and a shank extending from the bit tip, an elongated spacer having an inner diameter and an opening that provides access to the inner diameter, and a stopper with a compliant material and having a hole through the stopper. The opening extends along an entire length of the spacer from a first end of the spacer to a second end of the spacer, thereby allowing the spacer to be press-fit or snap-fit onto a mid-portion of the shank of the driver bit such that the inner diameter of the spacer receives the shank of the driver bit. The spacer can rotate independently of the driver bit. The stopper is removably affixable to the first end of the spacer, such that the bit tip of the driver bit extends through the hole of the stopper. Some such examples further include a washer between an upper surface of the spacer and an upper portion of the shank, wherein the washer acts as a barrier that stops the spacer from moving any further up the shank toward the rotary tool. The washer may be plastic or other rigid non-metal material. A metal washer can be used as well, but may generate more heat.

In another embodiment, a spacer assembly designed for use around a shank of a driver bit includes a body region having a first outer diameter and an inner diameter, and a neck region extending from one end of the body region and having a second outer diameter less than the first outer diameter and having the inner diameter. An opening extends through a portion of both the body region and the neck region, and along an entire length of both the body region and the neck region. The opening provides access to the inner diameter. The spacer assembly may be made of a resilient material such as plastic, and the opening can be sized so that the spacer assembly can be press-fit or snap-fit onto a mid-portion of the shank of the driver bit. The neck region can be configured to insert into the hole of a donut-like stopper element (used to set the depth of a fastener head), and the opposite end of the body region can be configured to abut a wider portion of the shank so that the spacer assembly cannot slide past that wider portion. In other examples, the opposite end of the body region can be configured to abut a washer that in turn abuts a wider portion or other feature of the shank so the spacer assembly cannot slide past that portion of the shank.

The accompanying figures further demonstrate some example embodiments of a depth setter tool. The example dimensions and materials depicted are not intended to be limiting on the present disclosure; rather, any number of spacer-stopper configurations that can spin independent of the driver bit will be appreciated in light of this disclosure, such as any configurations including a spacer that snap-fits or press-fits onto a midportion of a driver bit (such as the narrower torsion zone of driver bit, sometimes referred to as an impact bit) and a donut-like stopper that can be passed over a driver bit tip and engaged with the spacer.

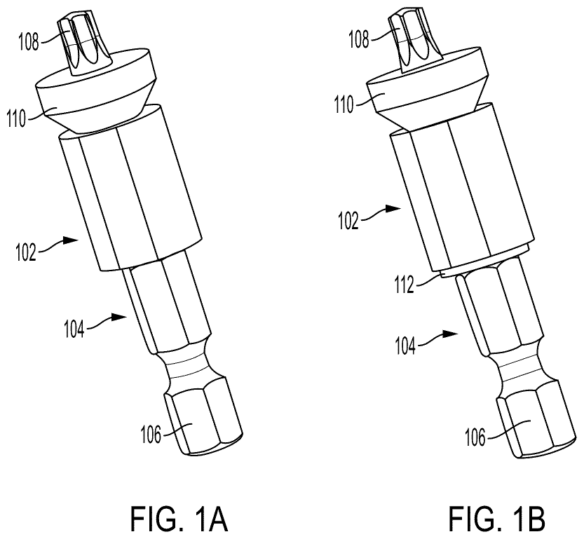

As can be seen in FIG. 1A, the depth setter tool includes a plastic spacer 102 that is press-fit or snap-fit around the shank 104 of a driver bit, according to some embodiments. Spacer 102 may include, for example, a nylon material or any other generally hard resilient plastic material. Other materials may be used as well, such as metal, hardened rubber, or any other material that allows for an elongated snap-fit or press-fit structure onto a drive shank as described herein). According to some embodiments, spacer 102 may be formed by injection molding. In some cases, spacer 102 may snap-fit or press-fit onto or otherwise around a portion of shank 104 that necks down to a smaller diameter such that the spacer can rotate freely about shank 104, but is limited in axial movement along shank 104. In some examples, spacer 102 cannot move at all axially along shank 104 or otherwise very little (e.g., less than 1/32 of an inch). Shank 104 may have an end connector 106 at its proximal end (chuck end) for coupling with a rotary tool such as an electric or pneumatic drill. In some examples, the bit is an impact bit having a necked-down midportion configured with an axial length and diameter that are selected to allow for elastic deformation so that end connector 106 can be rotated a number of degrees (e.g., 1 to 15 degrees) with respect to a distal bit tip 108 without snapping or permanently deforming bit tip 108.

According to some embodiments, spacer 102 includes a neck region at one end where a stopper 110 (e.g., rubber or plastic washer) is affixed. Stopper 110 may have a donut-shaped structure to fit around the neck region of spacer 102. In the depicted example, the donut-shape has a tapered or trapezoidal profile. Other examples may be more disk-like or flat with no taper. As will be appreciated, the thickness of stopper (along the longitudinal axis of the driver bit) can be varied to provide different counterbore depths. In some examples, one or more additional flat spacers of varying thickness can be added to adjust the overall thickness of stopper 110 (and depth of counterbore).

FIG. 1B illustrates another example of a depth setter tool that includes the same components as discussed in FIG. 1A and also includes a washer 112 between one end of spacer 102 and a portion of shank 104. In some embodiments, washer 112 is arranged to contact the end of spacer 102 that is opposite from the end coupled to stopper 110. Washer 112 may be any suitable material, such as nylon or any other plastic material. In some examples, washer 112 is a metal material, such as brass. Washer 112 may be capable of moving independently of both shank 104 and spacer 102, although it could be secured to shank 104 as well (or otherwise part of shank 104). Allowing the washer 112 to spin independently of shank 104 may generate less heat. According to some embodiments, washer 112 is included to provide a robust stop point that prevent spacer 102 from sliding further down shank 104 toward end 106 during drive operations, and may also reduce the friction between the end of spacer 102 and shank 104. In configurations that do not include washer 112 (like FIG. 1A), shank 104 may include a thicker portion of shank 104 to which the end surface of spacer 102 abuts, thus creating a stop point that prevent spacer 102 from sliding further down shank 104. In still other examples, a lip or rim protruding laterally outward from upper portion of shank 104 (like a built-in or integral washer like surface) may be used to provide a stop point that either the spacer 102 or washer 112 (if present) abut. Other such variations may be used as well.

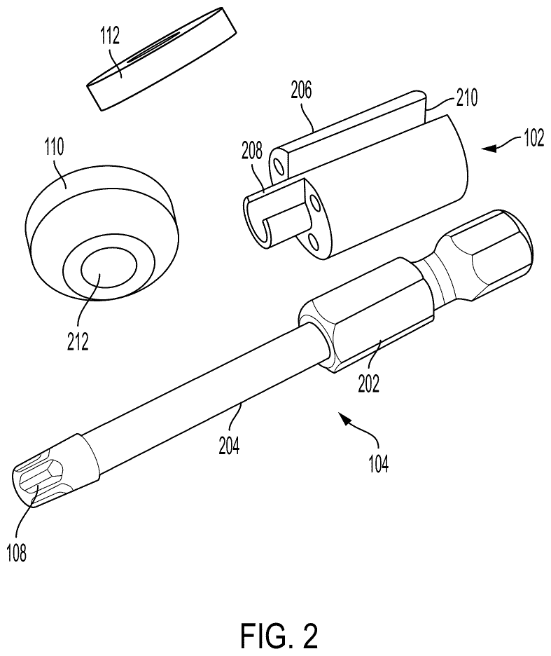

FIG. 2 provides an illustration of the various disassembled components of the depth setter tool, according to some embodiments. With the spacer 102 and stopper 110 removed, along with the washer 112 (if present), shank 104 can be seen to have a body portion 202 and a narrower neck portion 204. According to some embodiments, spacer 102 is designed to snap around neck portion 204 such that spacer 102 can press or snap onto, and spin freely around, neck portion 204. The larger body portion 202 provides a stop point that prevents spacer 102 from sliding off of the bit over body portion 202. If the larger body portion 202 is not quite sufficient to provide such a stop point, then washer 112 can be used, where the hole of washer 112 is sized to receive the narrow neck portion 204 but more robustly abut the larger body portion 202. According to some embodiments, bit tip 108 also has a larger diameter compared to neck portion 204 to prevent spacer 102 from sliding off over bit tip 108. If present, the hole of washer 112 may be sized to slide over both bit tip 108 and neck portion 204, but still provide a robust abutment to the larger body portion 202. In still other examples, washer 112 may be “trapped” (e.g., during manufacturing of driver bit) between bit tip 108 and larger body portion 202 so that it can freely slide along neck portion 204 but not passed either end of shank 104.

According to some embodiments, spacer 102 includes a spacer body 206 and a spacer neck 208 extending away from one end of spacer body 206. Spacer body 206 may be coaxially aligned with spacer neck 208 and may have a larger diameter compared to spacer neck 208. According to some embodiments, each of spacer body 206 and spacer neck 208 has a generally circular cross-section, although other shapes are possible as well, such as hexagonal or octagonal. According to some embodiments, spacer 102 is hollow along its central axis such that spacer 102 is capable of fitting around neck portion 204 of shank 104. According to some embodiments, an opening 210 extends through a portion of spacer 102 and along an entire length of spacer 102. Accordingly, opening 210 extends across both spacer body 206 and spacer neck 208. Opening 210 may be a slot or trench opening that extends through the wall of both spacer body 206 and spacer neck 208 towards the hollow central axis of spacer 102. Opening 210 allows spacer 102 to be snap-fit or press-fit over neck portion 204 of shank 104. Accordingly, a width of opening 210 may be slightly smaller than the diameter of neck portion 204. The force of pressing together opening 210 and neck portion 204 causes spacer 102 to elastically deform outwards, allowing neck portion 204 to drop into the central portion of spacer 102. At that point, spacer 102 may elastically deform back to its original shape thus preventing neck portion 204 from falling out from being within the hollow region along the central axis of spacer 102. An inner diameter of the hollow region along the central axis of spacer 102 is slightly larger than the diameter of neck portion 204, which allows spacer 102 to rotate freely around neck portion 204.

Stopper 110 includes a hole 212 that extends through the entire length of stopper 110 and along the central axis of stopper 110. According to some embodiments, hole 212 is designed to fit snuggly over spacer neck 208 to secure stopper 110 over spacer neck 208. Thus, in some examples, the diameter of hole 212 may be slightly smaller than the outer diameter of spacer neck 208. The above relevant description with respect to stopper 110 is equally applicable here.

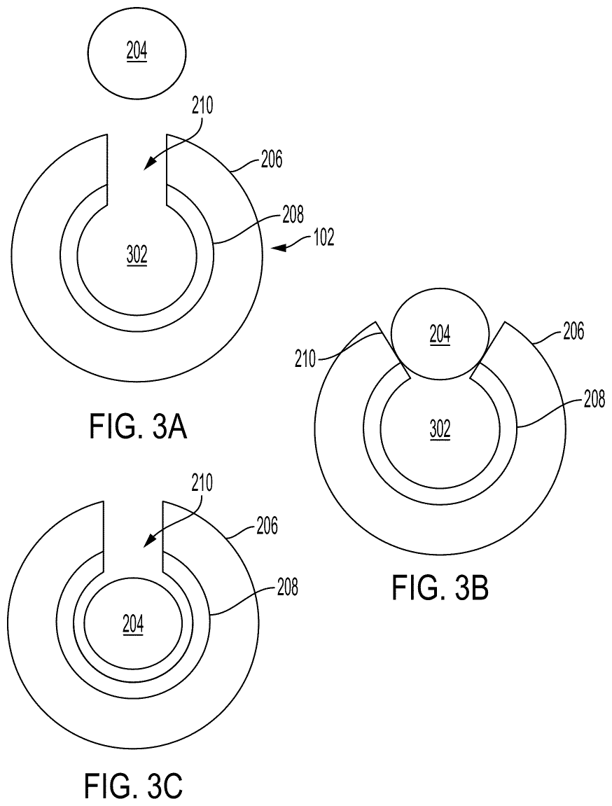

FIGS. 3A-3C illustrate cross-section views of an example process of pressing or snapping spacer 102 onto neck portion 204 of shank 104. In FIG. 3A, spacer 102 and neck portion 204 are brought together with opening 210 facing neck portion 204. A hollow region 302 is also identified that runs along a central axis of both spacer body 206 and spacer neck 208.

In FIG. 3B, spacer 102 is pressed onto neck portion 204 such that neck portion 204 enters into opening 210. According to some embodiments, both spacer body 206 and spacer neck 208 elastically deform to accommodate the wider neck portion 204 entering through the narrower opening 210. This pressing action can be accomplished, for example, with the user's fingers and thumbs, or a pair of pliers.

In FIG. 3C, neck portion 204 has been pushed through opening 210 and settles within hollow region 302 and both spacer body 206 and spacer neck 208 elastically deformed back to their original position, thus bringing spacer 102 back to a shape with opening 210 having a smaller width compared to the diameter of neck portion 204. Thus, neck portion 204 remains within hollow opening 302 and cannot escape back out through opening 210 unless enough force is exerted to again elastically deform both spacer body 206 and spacer neck 208. In this position, spacer 102 may freely rotate around neck portion 204. Note that this configuration allows for spacer 102 to be removable from neck portion 204 by exerting a sufficient removal force of neck portion 204 against opening 210.

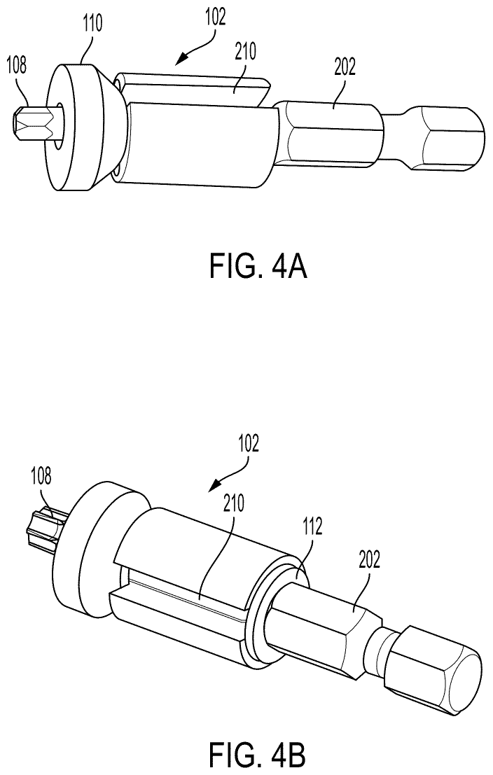

Stopper 110 may be snuggly fit over, snapped onto, or otherwise engaged with spacer neck 208, such that spacer 102 and stopper 110 may spin together around neck portion 204 as a single unit. FIG. 4A illustrates a view of an assembled depth setter tool with stopper 110 over spacer neck 208. According to some embodiments, bit tip 108 extends outward from the hole of stopper 110. Bit tip 108 may be shaped to match the recess pattern in a given fastener. Example such patterns include straight, cruciform, star, hexagonal, square, and triangular patterns, although any suitable driver bit tip/fastener head pattern can be used. Spacer 102 is first snap-fit or press-fit over neck region 204 followed by stopper 110 being snuggly fit over, snapped onto, or otherwise engaged with spacer neck 208, according to some embodiments. FIG. 4B illustrates another view of an assembled depth setter tool which includes the additional washer 112 between spacer 102 and body portion 202 of shank 104. The presence of washer 112 may reduce wear on the end of spacer 102 adjacent to body portion 202, and may further provide a more robust stopping point that prevents spacer 102 from sliding onto body portion 202 and further along the shank toward the rotary tool during fastening operations.

In operation, the depth setter tool is used to drive a fastener engaged by driver bit tip 108 into a workpiece and below the surface of the workpiece until the front face of stopper 110 contacts the surface of the workpiece. At that time, both spacer 102 and stopper 110 will come to a stop to prevent marring of the surface of the workpiece while the driver bit (e.g., shank 104) can continue to spin responsive to the rotary tool and independent of spacer 102 and stopper 110. However, the driver bit is prevented from driving further into the workpiece after contact is made by stopper 110, thus setting the depth of the fastener. Stopper 110 can be made of different materials, but in some examples is rubber, which is gentle on the workpiece. Halting the rotation of stopper 110 as it contacts the workpiece may be accompanied by a distinctive sound that alerts the user that the desired depth has been reached.

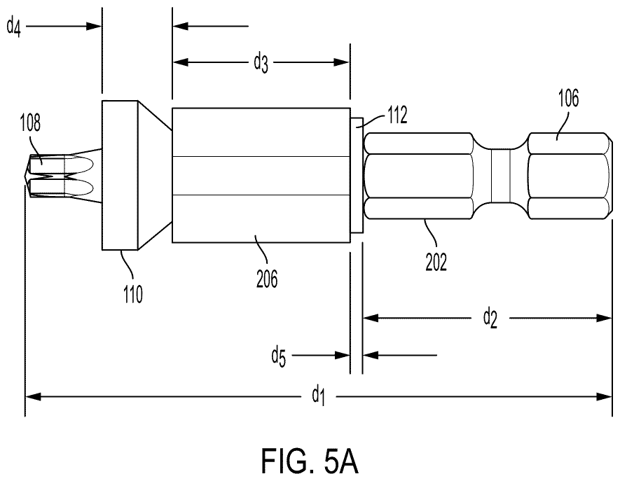

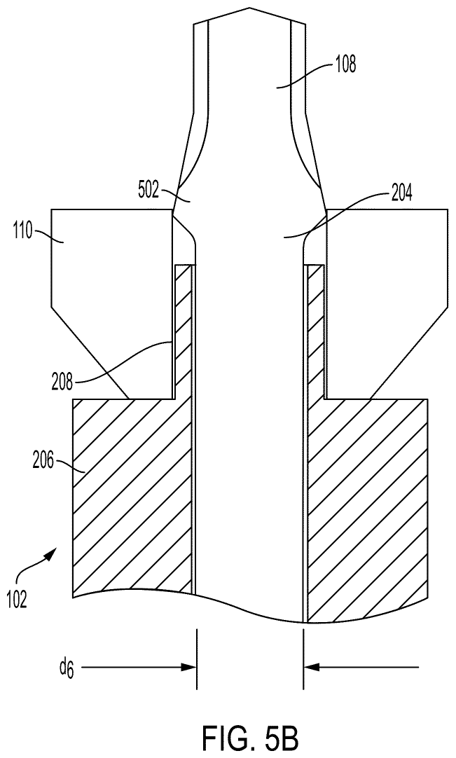

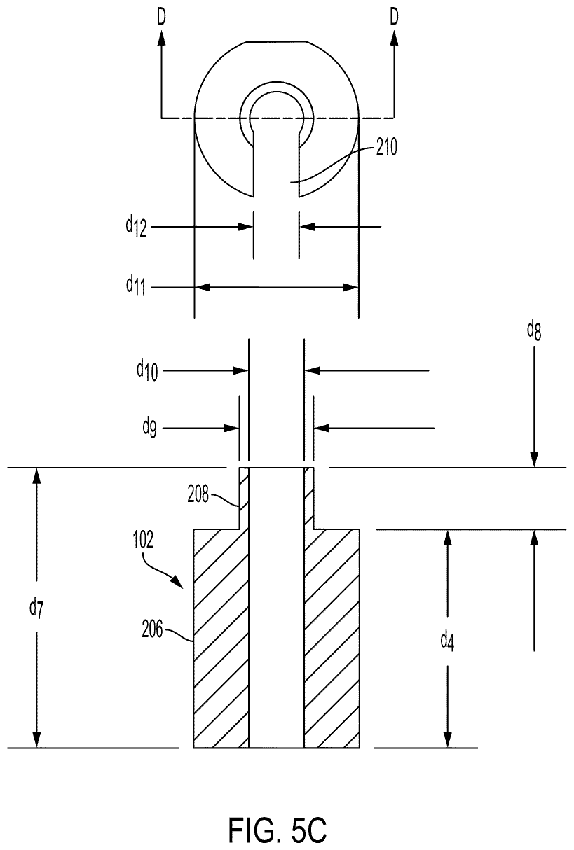

FIG. 5A illustrates a side view of a depth setter tool along with example dimensions of various components. A length d₁ of the depth setter tool (e.g., from bit tip 108 to end connector 106) may be between about 1.500″ and 2.500″, such as around 1.965″. In an example, a back end of the shank that includes both body portion 202 and end connector 106 has a length d₂ between about 0.825″ and about 0.850″, such as around 0.837″. In an example, a length d₃ of spacer body 206 is between about 0.500″ and about 0.700″, such as around 0.595″. In an example, a thickness (or length) d₄ of stopper 110 is between about 0.20″ and about 0.30″, such as around 0.24″. As discussed above, in some embodiments, washer 112 is provided between spacer body 206 and body portion 202 of the shank. Washer 112 may have a thickness d₅ between about 0.025″ and about 0.050″, such as around 0.038″.

FIG. 5B illustrates a cross-section view through a distal end of the depth setter tool where stopper 110 fits over spacer neck 208. Bit tip 108 includes a flared region 502 that is wider than neck portion 204 of the shank. According to some embodiments, flared region 502 prevents spacer 102 and stopper 110 from slipping off of the shank over bit tip 108. In an example, a diameter d₆ of neck portion 204 is between about 0.125″ and about 0.150″, such as around 0.135″. The inner diameter of both spacer body 206 and spacer neck 208 is slightly larger than d₆ to allow spacer 102 to spin freely around neck portion 204.

FIG. 5C illustrates top-down and cross-section views of spacer 102, according to some embodiments. The bottom illustration is a cross-section taken across the D-D plane from the top illustration. Spacer 102 may have a full length d₇ (including both spacer body 206 and spacer neck 208) between about 0.700″ and about 0.800″, such as around 0.765″. In an example, spacer neck 208 has a length d₈ between about 0.150″ and about 0.200″, such as around 0.170″, has an outer diameter d₉ between about 0.180″ and about 0.220″, such as around 0.200″, and has an inner diameter d₁₀ between about 0.140″ and about 0.160″, such as around 0.150″. In an example, spacer body 206 has an outer diameter d₁₁ between about 0.400″ and about 0.500″, such as around 0.450″ and an inner diameter substantially the same as the inner diameter d₁₀ of spacer neck 208. In an example, opening 210 has a width d₁₂ between about 0.115″ and about 0.135″, such as around 0.125″. The previously incorporated provisional application also includes example configurations and dimensions, and those examples are referenced here as well.

### FURTHER EXAMPLE EMBODIMENTS

The following examples pertain to further embodiments, from which numerous permutations and configurations will be apparent.

Example 1 is a depth setter tool that includes a spacer and a stopper having a compliant material and designed to engage a first end of the spacer. The spacer has an inner diameter sized to fit around a shank of a driver bit such that the spacer can rotate about an axis passing through a center of the driver bit and independently of the driver bit. The spacer further has an opening extending along an entire length of the spacer from the first end of the spacer to a second end of the spacer. The opening provides access to the inner diameter thereby allowing the spacer to be engaged onto the shank of the driver bit.

Example 2 includes the depth setter tool of Example 1, wherein the spacer comprises a body region and a neck region extending from the body region, wherein the stopper engages the neck region of the spacer.

Example 3 includes the depth setter tool of Example 2, wherein the neck region has a first outer diameter and the body region has a second outer diameter larger than the first outer diameter.

Example 4 includes the depth setter tool of Example 2 or 3, wherein the neck region and the body region of the spacer both have the inner diameter.

Example 5 includes the depth setter tool of any one of Examples 1-4, wherein the spacer comprises nylon and the compliant material comprises rubber.

Example 6 includes the depth setter tool of any one of Examples 1-5, wherein the spacer is engageable onto the shank of the driver bit by snap-fit or press-fit.

Example 7 includes the depth setter tool of any one of Examples 1-6, wherein the shank comprises a body portion and a neck portion having a smaller diameter compared to the body portion, and wherein the spacer can be snap-fit or press-fit around the neck portion of the shank.

Example 8 includes the depth setter tool of Example 7, further comprising a washer between one end of the spacer and the body portion of the shank.

Example 9 includes the depth setter tool of Example 8, wherein the washer comprises nylon.

Example 10 is a depth setter tool that includes a driver bit having a bit tip and a shank extending from the bit tip, an elongated spacer having an inner diameter and an opening that provides access to the inner diameter, and a stopper having a hole. The opening of the elongated spacer extends along an entire length of the spacer from a first end of the spacer to a second end of the spacer, thereby allowing the spacer to be press-fit or snap-fit onto the shank of the driver bit such that the inner diameter of the spacer receives the shank of the driver bit, and the spacer can rotate independently of the driver bit. The stopper is removably affixable to the first end of the spacer, such that the bit tip of the driver bit extends through the hole of the stopper.

Example 11 includes the depth setter tool of Example 10, wherein the driver bit comprises a neck portion along its axial length having a smaller diameter compared to adjacent regions of the driver bit.

Example 12 includes the depth setter tool of Example 11, wherein the spacer is configured to be press-fit or snap-fit around the neck portion of the driver bit.

Example 13 includes the depth setter tool of any one of Examples 10-12, wherein the spacer comprises a body region and a neck region extending from the body region, wherein the stopper is removably affixable to the neck region of the spacer.

Example 14 includes the depth setter tool of Example 13, wherein the neck region has a first outer diameter and the body region has a second outer diameter larger than the first outer diameter.

Example 15 includes the depth setter tool of Example 13 or 14, wherein the neck region and the body region of the spacer both have the same inner diameter.

Example 16 includes the depth setter tool of any one of Examples 10-15, wherein the spacer comprises nylon and the stopper comprises a compliant material.

Example 17 includes the depth setter tool of Example 16, wherein the compliant material comprises rubber.

Example 18 includes the depth setter tool of any one of Examples 10-17, wherein the shank comprises a body portion and a neck portion having a smaller diameter compared to the body portion, and wherein the spacer is configured to be snap-fit or press-fit around the neck portion of the shank.

Example 19 includes the depth setter tool of Example 18, further comprising a washer between one end of the spacer and the body portion of the shank.

Example 20 includes the depth setter tool of Example 19, wherein the washer comprises nylon.

Example 21 is a spacer assembly configured for use around a shank of a driver bit. The spacer assembly includes a body region having a first outer diameter and an inner diameter and a neck region extending from one end of the body region and having a second outer diameter less than the first out diameter and having the inner diameter. An opening extends through a portion of both the body region and the neck region, and along an entire length of both the body region and the neck region. The opening provides access to the inner diameter.

Example 22 includes the spacer assembly of Example 21, further comprising a stopper comprising a compliant material and a hole configured to fit around the neck region.

Example 23 includes the spacer assembly of Example 21 or 22, wherein the opening has a width that is smaller than the inner diameter.

Example 24 includes the spacer assembly of any one of Examples 21-23, wherein the body region and neck region are part of a monolithic and continuous piece.

Example 25 includes the spacer assembly of Example 24, wherein the monolithic and continuous piece is made of nylon.

The foregoing description of example embodiments of the disclosure has been presented for the purposes of illustration and description. It is not intended to be exhaustive or to limit the disclosure to the precise forms disclosed. Many modifications and variations are possible in light of this disclosure. It is intended that the scope of the disclosure be limited not by this detailed description, but rather by the claims appended hereto.

What is claimed is:

1. A depth setter tool, comprising:
a spacer having an inner diameter sized to fit around a shank of a driver bit such that the spacer can rotate about an axis passing through a center of the driver bit and independently of the driver bit, the spacer further having an opening extending along an entire length of the spacer from a first end of the spacer to a second end of the spacer, the opening providing access to the inner diameter thereby allowing the spacer to be engaged onto the shank of the driver bit; and
a stopper comprising a compliant material and configured to engage the first end of the spacer.

2. The depth setter tool of claim 1, wherein the spacer comprises a body region and a neck region extending from the body region, wherein the stopper engages the neck region of the spacer.

3. The depth setter tool of claim 2, wherein the neck region has a first outer diameter and the body region has a second outer diameter larger than the first outer diameter.

4. The depth setter tool of claim 2, wherein the neck region and the body region of the spacer both have the inner diameter.

5. The depth setter tool of claim 1, wherein the spacer is engageable onto the shank of the driver bit by snap-fit or press-fit.

6. The depth setter tool of claim 1, wherein the shank comprises a body portion and a neck portion having a smaller diameter compared to the body portion, and wherein the spacer can be snap-fit or press-fit around the neck portion of the shank.

7. The depth setter tool of claim 6, further comprising a washer between one end of the spacer and the body portion of the shank.

8. A depth setter tool, comprising:
a driver bit having a bit tip and a shank extending from the bit tip;
an elongated spacer having an inner diameter and an opening that provides access to the inner diameter, the opening extending along an entire length of the spacer from a first end of the spacer to a second end of the spacer, thereby allowing the spacer to be press-fit or snap-fit onto the shank of the driver bit such that the inner diameter of the spacer receives the shank of the driver bit, and the spacer can rotate independently of the driver bit; and
a stopper having a hole, the stopper removably affixable to the first end of the spacer, such that the bit tip of the driver bit extends through the hole of the stopper.

9. The depth setter tool of claim 8, wherein the driver bit comprises a neck portion along its axial length having a smaller diameter compared to adjacent regions of the driver bit.

10. The depth setter tool of claim 9, wherein the spacer is configured to be press-fit or snap-fit around the neck portion of the driver bit.

11. The depth setter tool of claim 8, wherein the spacer comprises a body region and a neck region extending from the body region, wherein the stopper is removably affixable to the neck region of the spacer.

12. The depth setter tool of claim 11, wherein the neck region has a first outer diameter and the body region has a second outer diameter larger than the first outer diameter.

13. The depth setter tool of claim 11, wherein the neck region and the body region of the spacer both have the same inner diameter.

14. The depth setter tool of claim 8, wherein the shank comprises a body portion and a neck portion having a smaller diameter compared to the body portion, and wherein the spacer is configured to be snap-fit or press-fit around the neck portion of the shank.

15. The depth setter tool of claim 14, further comprising a washer between one end of the spacer and the body portion of the shank.

16. A spacer assembly configured for use around a shank of a driver bit, the spacer assembly comprising:
a body region having a first outer diameter and an inner diameter; and
a neck region extending from one end of the body region and having a second outer diameter less than the first out diameter and having the inner diameter,
wherein an opening extends through a portion of both the body region and the neck region, and along an entire length of both the body region and the neck region, the opening providing access to the inner diameter.

17. The spacer assembly of claim 16, further comprising a stopper comprising a compliant material and a hole configured to fit around the neck region.

18. The spacer assembly of claim 16, wherein the opening has a width that is smaller than the inner diameter.

19. The spacer assembly of claim 16, wherein the body region and neck region are part of a monolithic and continuous piece.

20. The spacer assembly of claim 19, wherein the monolithic and continuous piece is made of nylon.
